(19) United States
(12) Patent Application Publication
(10) Pub. No.: US 2026/0065865 A1
(43) Pub. Date: Mar. 5, 2026

(54) DISPLAY PANEL AND PIXEL CIRCUIT THEREOF

(71) Applicant: Powerchip Micro Device Corporation, Hsinchu (TW)

(72) Inventors: Chen Chi Lin, Hsinchu (TW); Jih Fon Huang, Hsinchu (TW)

(73) Assignee: Powerchip Micro Device Corporation, Hsinchu (TW)

(21) Appl. No.: 19/087,591

(22) Filed: Mar. 24, 2025

(30) Foreign Application Priority Data
Sep. 4, 2024 (TW) 113133499

(51) Int. Cl. G09G 3/3258; G09G 3/3233

(52) U.S. Cl. CPC G09G 3/3258; G09G 3/3233; G09G 2300/0465; G09G 2300/0852; G09G 2310/08

(57) ABSTRACT

A display panel and a pixel circuit are provided. The pixel includes a driving transistor, a first switch, a second switch, and a third switch. The driving transistor and a light emitting device are coupled in series, and controlled by a driving voltage to drive the light emitting device. The first switch is coupled between a control end of the driving transistor and a source line, and controlled by a first gate signal. The second switch, the driving transistor, and the light emitting device are serially coupled between a power voltage and a reference ground voltage, and controlled by a second gate signal. The third switch is coupled between the light emitting device and a setting/sensing voltage transmission wire, and controlled by a third gate signal. A data writing operation and a voltage resetting operation of the control end of the driving transistor are performed by the same first switch.

### CROSS-REFERENCE TO RELATED APPLICATION

This application claims the priority benefit of Taiwan application serial no. 113133499, filed on Sep. 4, 2024. The entirety of the above-mentioned patent application is hereby incorporated by reference herein and made a part of this specification.

### BACKGROUND

### Technical Field

The disclosure relates to a display panel and a pixel circuit thereof, and in particular to a display panel and a pixel circuit thereof capable of reducing layout area and improving display resolution.

### Description of Related Art

With the advancement of electronic technology, people have increasingly higher performance requirements for display devices in electronic products. For instance, in the case of display devices applied in head mount displays, high-resolution display quality has become an important demand for people nowadays

However, to improve display quality, taking a light emitting diode display panel as an example, the pixel circuit in current display panels needs to be equipped with multiple transistors, multiple capacitors, and multiple signal lines. Under such conditions, the size of the pixel circuit will be increased, resulting in a limitation on the number of pixel circuits that can be laid out on a display panel with a fixed area. As a result, the resolution of the display panel cannot be effectively improved.

### SUMMARY

The disclosure provides a display panel and a pixel circuit thereof, which can effectively improve a display resolution thereof.

A pixel circuit of the disclosure includes a driving transistor, a first switch, a second switch, and a third switch. The driving transistor and the light emitting device are coupled in series, and are controlled by the driving voltage to drive the light emitting device. The first switch is coupled between the control end of the driving transistor and the source line, and is controlled by the first gate signal. The second switch, the driving transistor, and the light emitting device are coupled in series between the power voltage and the reference ground voltage, and are controlled by the second gate signal. The third switch is coupled between the light emitting device and the setting/sensing voltage transmission wire, and is controlled by the third gate signal. A data writing operation and a voltage resetting operation on the control end of the driving transistor are performed by the same first switch when turned on.

A display panel of the disclosure includes a first pixel circuit and a second pixel circuit. The first pixel circuit and the second pixel circuit have the same circuit structure as the aforementioned pixel circuit. Moreover, the first pixel circuit and the second pixel circuit may share the same second switch.

Based on the above, in the pixel circuit of the disclosure, the data writing operation and the voltage resetting operation on the control end of the driving transistor are performed by the same first switch when turned on. Therefore, in the pixel circuit of the disclosure, by using relatively few switch elements to construct, a layout area of the pixel circuit is effectively reduced, and the display resolution of the formed display panel can be improved.

### BRIEF DESCRIPTION OF THE DRAWINGS

FIG. 1 is a schematic diagram of a pixel circuit according to an embodiment of the disclosure.

FIG. 2 is an operation waveform diagram of a pixel circuit 100 according to the embodiment of FIG. 1.

FIG. 3 is a schematic diagram of operation waveforms of multiple pixel circuits according to an embodiment of the disclosure.

FIG. 4 is a schematic diagram of a pixel circuit according to an embodiment of the disclosure.

FIG. 5 is an operation waveform diagram of a pixel circuit 400 according to the embodiment of FIG. 4 of the disclosure.

FIG. 6A is a schematic diagram of a display panel according to an embodiment of the disclosure.

FIG. 6B is a schematic top diagram of a layout structure of a display panel 600 according to the embodiment of FIG. 6A.

FIG. 7 is a schematic diagram of a display panel according to another embodiment of the disclosure.

FIG. 8A is a schematic diagram of a display panel according to another embodiment of the disclosure.

FIG. 8B is a schematic top diagram of a layout structure of a display panel 800 according to the embodiment of FIG. 8A.

FIG. 9 is a schematic diagram of a display panel according to another embodiment of the disclosure.

FIG. 10A is a schematic diagram of a display panel according to another embodiment of the disclosure.

FIG. 10B is a schematic top diagram of a layout structure of a display panel 1000 according to the embodiment of FIG. 10A.

FIG. 11A and FIG. 11B respectively illustrate two different implementations of a pixel circuit according to an embodiment of the disclosure.

FIG. 11C illustrates operation waveforms of pixel circuits of FIG. 11A and FIG. 11B.

### DESCRIPTION OF THE EMBODIMENTS

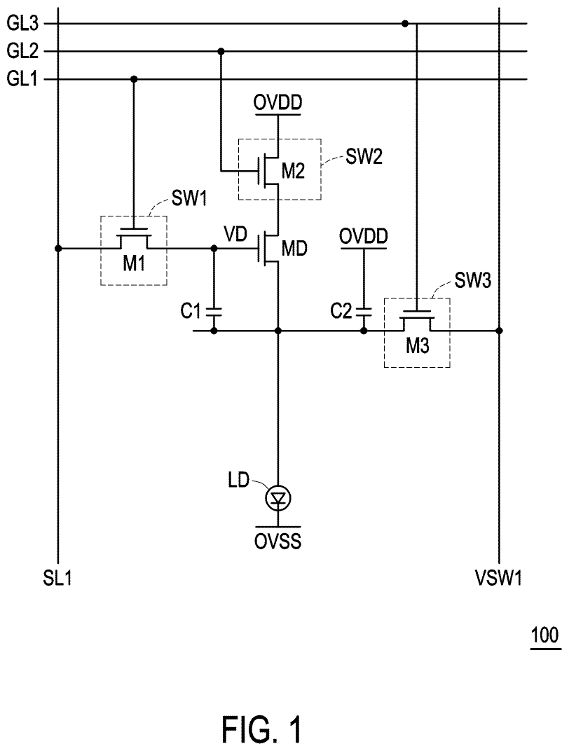

With reference to FIG. 1, FIG. 1 is a schematic diagram of a pixel circuit according to an embodiment of the disclosure. A pixel circuit 100 includes a driving transistor MD, transistors M1 to M3, and capacitors C1 and C2. The transistors M1 to M3 are configured to construct switches SW1 to SW3 respectively. The driving transistor MD and a light emitting device LD are coupled in series. In this embodiment, a first end of the driving transistor MD receives a power voltage OVDD, a second end of the driving transistor MD is coupled to an anode of the light emitting device LD, and a cathode of the light emitting device LD is coupled to a reference ground voltage OVSS. A control end of the driving transistor MD may receive a driving voltage VD and generate a driving current to drive the light emitting device LD to emit light according to the driving voltage VD.

Furthermore, the switch SW1 is coupled between the control end of the driving transistor MD and a source line SL1, where a first end of the switch SW1 is coupled to the source line SL1, and a second end of the switch SW1 is coupled to the control end of the driving transistor MD. A control end of the switch SW1 is coupled to a first gate line to receive a gate signal GL1, and the switch SW1 is controlled by the gate signal GL1 to be turned on or turned off. The switch SW2, the driving transistor MD, and the light emitting device LD are coupled in series between the power voltage OVDD and the reference ground voltage OVSS. A control end of the switch SW2 is coupled to a second gate line to receive a gate signal GL2, and the switch SW2 is controlled by the gate signal GL2 to be turned on or turned off. The switch SW3 is coupled between a coupling end point of the driving transistor MD and the light emitting device LD and a setting/sensing voltage transmission wire VSW1.

The capacitor C1 is coupled to the control end of the driving transistor MD and between the coupling end point of the driving transistor MD and the light emitting device LD. The capacitor C2 is coupled to the power voltage OVDD and between the control end of the driving transistor MD and the coupling end point of the driving transistor MD and the light emitting device LD, and is configured to serve as a voltage stabilizing capacitor.

In this embodiment, the light emitting device LD may be a light emitting diode in any form, for instance, an organic light emitting diode (OLED), a mini LED, a micro LED, and so on. In addition, the transistors M1 to M3 serving as the switches SW1 to SW3 and the driving transistor MD may be N-type transistors.

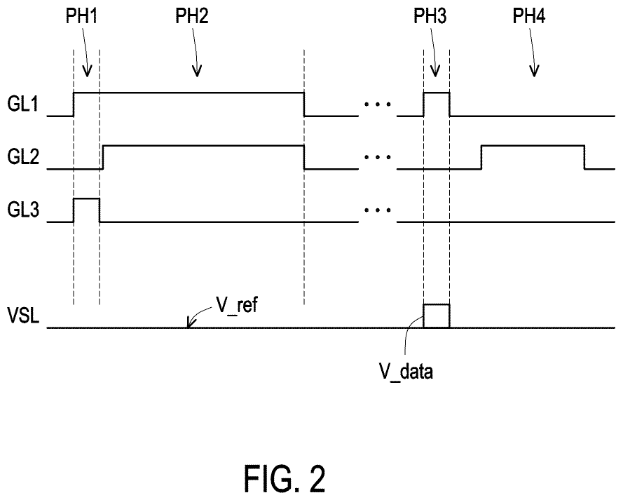

Regarding the operation details of the pixel circuit 100, please refer to FIG. 1 and FIG. 2 together, where FIG. 2 is an operation waveform diagram of a pixel circuit 100 according to the embodiment of FIG. 1. According to the embodiment of the disclosure, the pixel circuit 100 may perform operations sequentially in multiple phases PH1 to PH4. In phase PH1 (a resetting phase), the gate signals GL1 and GL3 may be at a high level, and the gate signal GL2 may be at a low level. Correspondingly, the switches SW1 and SW3 may be turned on, while the switch SW2 may be turned off. At this time, the switch SW1 may transmit a voltage VSL on the source line SL1 to the control end of the driving transistor MD. Herein, the voltage VSL on the source line SL1 at this time may be a reference voltage V_ref with a relatively low voltage value. By the turned-on switch SW1, the voltage VSL may be transmitted to perform a voltage resetting operation on a voltage at the control end of the driving transistor MD. In addition, by the turned-on switch SW3, a setting voltage on the setting/sensing voltage transmission wire VSW1 may be transmitted to the coupling end point of the driving transistor MD and the light emitting device LD, so as to reset the voltage at this end point.

In this embodiment, the reference voltage V_ref may be a voltage less than a threshold, for instance, 0V.

In phase PH2 (a compensation phase), the gate signals GL1 and GL2 may be at the high level, and the gate signal GL3 may be at the low level. Correspondingly, the switches SW1 and SW2 may be turned on, while the switch SW3 may be turned off. At this time, by the turned-on switch SW2, the first end of the driving transistor MD may receive the power voltage OVDD. Moreover, the relevant information (for instance, the voltage value of the conduction voltage) of a conduction voltage of the driving transistor MD may be recorded in the capacitor C1. Herein, a sum of the setting voltage, the conduction voltage of the driving transistor MD, and the voltage VSL on the source line SL1 may be less than a sum of a conduction voltage of the light emitting device LD and the reference ground voltage OVSS.

After the phase PH2 ends, the gate signals GL1, GL2, and GL3 may all be pulled down to the low level. Correspondingly, the switches SW1, SW2, and SW3 may be turned off.

In phase PH3 (a data writing phase) after the phase PH2, the gate signal GL1 may be pulled up to the high level, and the gate signals GL2 and GL3 may be maintained at the low level. Correspondingly, the switch SW1 may be turned on, while the switches SW2 and SW3 may be turned off. At the same time, the voltage VSL on the source line SL1 is a display data V_data. By the turned-on switch SW1, the display data V_data may be written to the control end of the driving transistor MD and stored in the capacitor C1.

In phase PH4 (a laser phase), the gate signal GL2 may be pulled up to the high level, and the gate signals GL1 and GL3 may be maintained at the low level. Correspondingly, the switch SW2 may be turned on, while the switches SW1 and SW3 may be turned off. At the same time, the driving transistor MD may receive the power voltage OVDD by the turned-on switch SW2. Meanwhile, the driving transistor MD may generate the driving current according to the driving voltage VD on the control end of the driving transistor MD and cause the driving current to flow by the light emitting device LD, so that the light emitting device LD emits light. In phase PH4, when the laser time of the light emitting device LD is long enough, the gate signal GL2 may be pulled down to the low level, and the switch SW2 may be turned off.

It is worth mentioning that, in the above description, the high voltage to which each of the gate signals GL1 to GL3 is pulled up may be a logic high voltage value set in the pixel circuit 100. The low voltage to which each of the gate signals GL1 to GL3 is pulled down may be a logic low voltage value set in the pixel circuit 100. The actual voltage values of the high voltage and the low voltage may be set up according to the power voltage OVDD and the reference ground voltage OVSS of the pixel circuit 100, which should not be construed as a limitation in the disclosure. Herein, the voltage value of the aforementioned high voltage may be greater than the voltage value of the aforementioned low voltage.

Incidentally, according to the embodiment of FIG. 1 of the disclosure, during a manufacturing process of the pixel circuit 100, before the light emitting device LD is completely set up, the switch SW3 may be turned on and configured to transmit a output current (serving as a sensing signal) generated by the driving transistor MD to the setting/sensing voltage transmission wire VSW1. The setting/sensing voltage transmission wire VSW1 may be connected to an external connection point. The engineer can read the sensing signal by the connection point and thereby perform a testing operation on the pixel circuit 100.

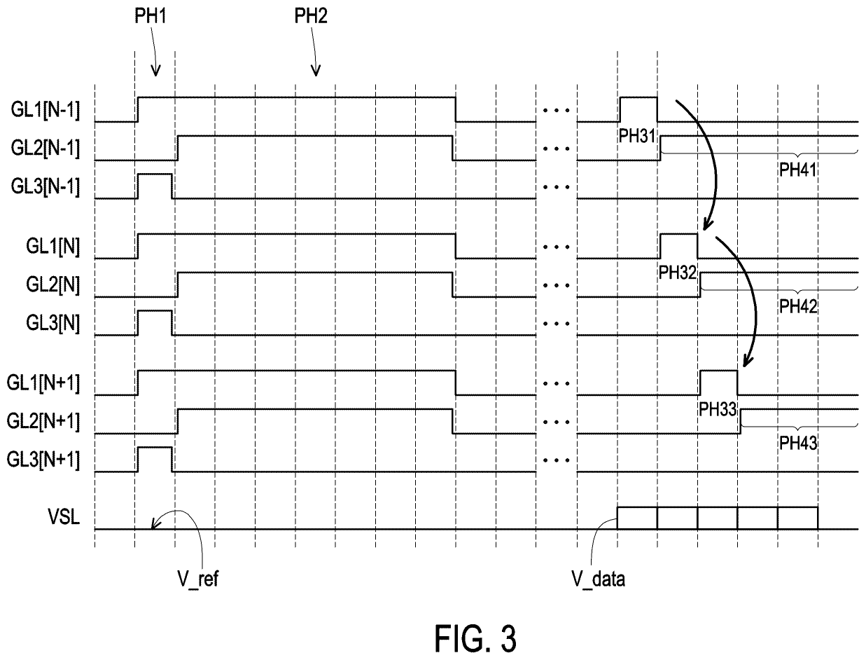

With reference to FIG. 3, FIG. 3 is a schematic diagram of operation waveforms of multiple pixel circuits according to an embodiment of the disclosure. In FIG. 3, multiple gate signals GL1[N−1]˜GL3[N+1] configured to control the pixel circuits arranged in different display rows are shown. The gate signals GL1[N−1] to GL3[N−1] correspond to the pixel circuit of the (N−1)th display row, the gate signals GL1[N] to GL3[N] correspond to the pixel circuit of the Nth display row, and the gate signals GL1[N+1] to GL3[N+1] correspond to the pixel circuit of the (N+1)th display row, where N is an integer greater than 1.

In this embodiment, the pixel circuits of different display rows may simultaneously perform the phases PH1 and PH2. At this time, the voltage VSL on the source line corresponding to the pixel circuit is the reference voltage V_ref.

After the phase PH2, the pixel circuits of different display rows may sequentially perform the subsequent phases PH31 to PH33 and PH41 to PH43. In this embodiment, the pixel circuit of the N−1th display row may first enter the phase PH31 and continue to enter the phase PH41 after the phase PH31 ends. The pixel circuit of the N-th display row then performs the phase PH32 after the phase PH31 of the pixel circuit of the N−1th display row ends. Similarly, the pixel circuit of the Nth display row may continue to perform the phase PH42 after the phase PH32 ends. The pixel circuit of the N+1th display row then performs the phase PH33 after the phase PH32 of the pixel circuit of the Nth display row ends. Similarly, the pixel circuit of the N+1th display row may continue to perform the phase PH43 after the phase PH33 ends.

From the phases PH31 to PH43, the voltage VSL on the source line corresponding to the pixel circuit may be the display data V_data of the pixel circuit corresponding to the N−1th display row to the N+1th display row respectively.

In other words, in this embodiment, from the perspective of the display panel, the pixel circuits of different display rows may enter the resetting phase (the phase PH1) and the compensation phase (the phase PH2) at the same time. Moreover, the pixel circuits of different display rows may sequentially enter the data writing phase (the phases PH31 to PH33) and the laser phase (the phases PH41 to PH43).

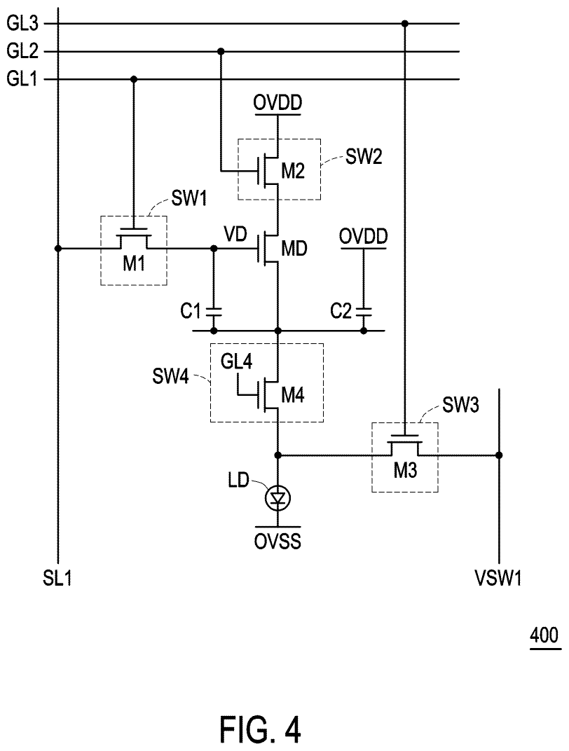

With reference to FIG. 4, FIG. 4 is a schematic diagram of a pixel circuit according to an embodiment of the disclosure. A pixel circuit 400 includes a driving transistor MD, transistors M1 to M4, and capacitors C1 and C2. The transistors M1 to M4 are respectively configured to construct switches SW1 to SW4.

In contrast to the pixel circuit 100 of the previous embodiment of FIG. 1, a coupling path between the driving transistor MD and the light emitting device LD in the pixel circuit of the present embodiment includes the switch SW4. The switch SW4 may be constructed by the transistor M4. The switch SW4 is controlled by a gate signal GL4 to be turned on or turned off. Furthermore, in this embodiment, the switch SW3 may be coupled between a coupling point of the switch SW4 and the light emitting device LD and the setting/sensing voltage transmission wire VSW1. In other words, the switch SW3 may be directly coupled between the anode of the light emitting device LD and the setting/sensing voltage transmission wire VSW1.

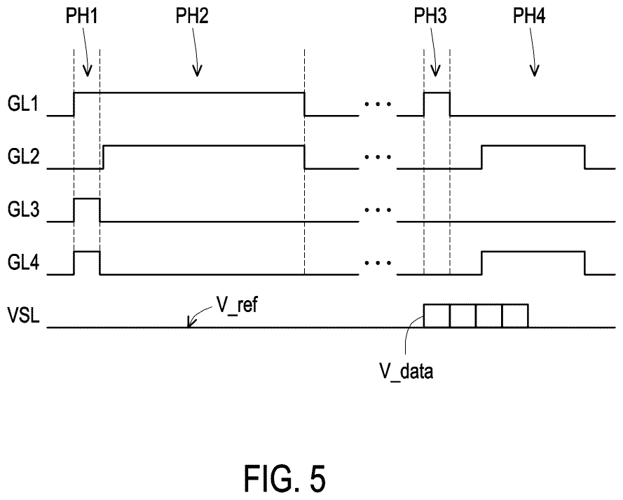

Regarding the operation details of the pixel circuit 400, reference may be made to FIG. 5, which is an operation waveform diagram of a pixel circuit 400 according to the embodiment of FIG. 4 of the disclosure. The pixel circuit 400 of the present embodiment may similarly perform operations sequentially in the phases PH1 to PH4. In phase PH1 (the resetting phase), the gate signals GL1, GL3, and GL4 may be at the high level, and the gate signal GL2 may be at the low level. Correspondingly, the switches SW1, SW3, and SW4 may be turned on, while the switch SW2 may be turned off. At this time, the switch SW1 may transmit the voltage VSL on the source line SL1 to the control end of the driving transistor MD. Herein, the voltage VSL on the source line SL1 may be a reference voltage V_ref with a relatively low voltage value. By the turned-on switch SW1, the voltage VSL may be transmitted to perform a resetting operation on the voltage at the control end of the driving transistor MD. Furthermore, by the turned-on switches SW3 and SW4, the setting voltage on the setting/sensing voltage transmission wire VSW1 may be transmitted to the coupling end point of the driving transistor MD and the light emitting device LD, thereby resetting the voltage at this end point.

In this embodiment, the reference voltage V_ref may be a voltage less than a threshold, for instance, 0V.

In phase PH2 (the compensation phase), the gate signals GL1 and GL2 may be at the high level, and the gate signals GL3 and GL4 may be at the low level. Correspondingly, the switches SW1 and SW2 may be turned on, while the switches SW3, SW4 may be turned off. At this time, by the turned-on switch SW2, the first end of the driving transistor MD may receive the power voltage OVDD. Moreover, the relevant information (for instance, the voltage value of the conduction voltage) of the conduction voltage of the driving transistor MD may be recorded in the capacitor C1. Herein, the sum of the setting voltage, the conduction voltage of the driving transistor MD, and the voltage VSL on the source line SL1 may be less than the sum of the conduction voltage of the light emitting device LD and the reference ground voltage OVSS.

After the phase PH2 ends, the gate signals GL1, GL2, GL3, and GL4 may all be pulled down to the low level. Correspondingly, the switches SW1, SW2, SW3, and SW4 may be turned off.

In phase PH3 (the data writing phase) after the phase PH2, the gate signal GL1 may be pulled up to the high level, and the gate signals GL2, GL3, and GL4 may be maintained at the low level. Correspondingly, the switch SW1 may be turned on, while switches SW2, SW3, and SW4 may be turned off. At the same time, the voltage VSL on the source line SL1 is the display data V_data. By the turned-on switch SW1, the display data V_data may be written to the control end of the driving transistor MD and stored in the capacitor C1.

In this embodiment, the switch SW4 is turned off in the phases PH2 and PH3, and is configured to isolate the light emitting device LD from the driving transistor MD.

In phase PH4 (the laser phase), the gate signals GL2 and GL4 may be pulled up to the high level, and the gate signals GL1 and GL3 may be maintained at the low level. Correspondingly, the switches SW2 and SW4 may be turned on, while the switches SW1 and SW3 may be turned off. At the same time, the driving transistor MD may receive the power voltage OVDD by the turned-on switch SW2. Meanwhile, the driving transistor MD may generate the driving current according to the driving voltage VD on the control end of the driving transistor MD and cause the driving current to flow by the switch SW4 and the light emitting device LD, so that the light emitting device LD emits light. In phase PH4, when the laser time of the light emitting device LD is long enough, the gate signals GL2 and GL4 may be pulled down to the low level, and the switches SW2 and SW4 are turned off.

It is worth mentioning that, according to the embodiments of the disclosure, when multiple pixel circuits 400 are arranged in different display rows, the pixel circuits 400 in different display rows may simultaneously enter the phases PH1 and PH2. The pixel circuits 400 in consecutive display rows may then sequentially enter the phases PH3 and PH4. The relevant details may be as described in the embodiment of FIG. 3, which is not be repeated herein.

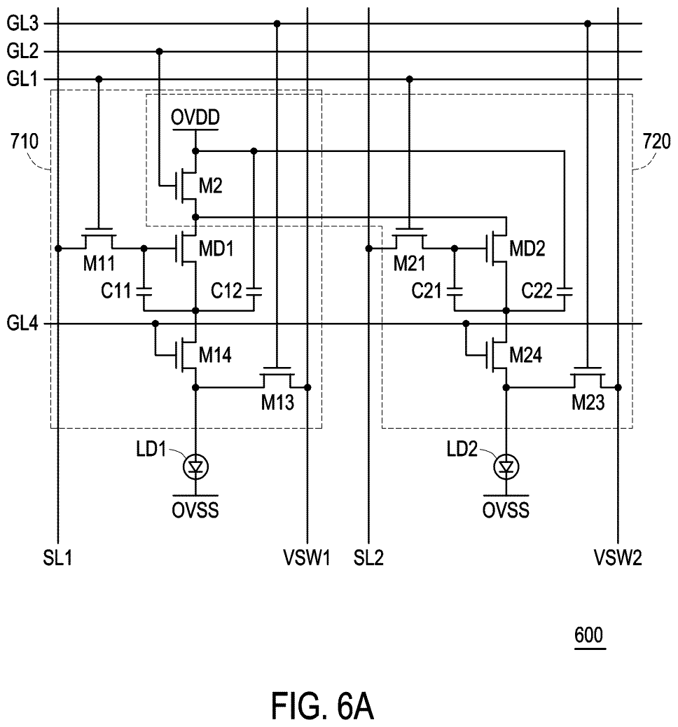

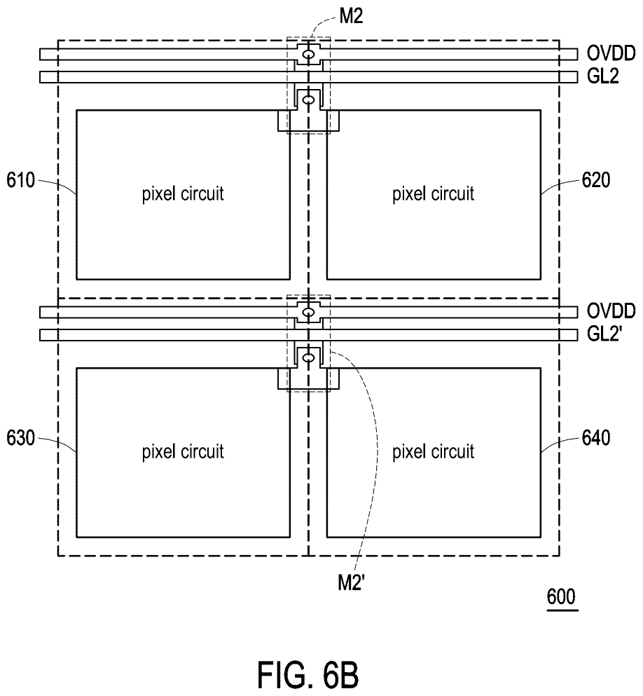

With reference to FIG. 6A, FIG. 6A is a schematic diagram of a display panel according to an embodiment of the disclosure. A display panel 600 includes multiple pixel circuits 610 and 620. In this embodiment, the pixel circuits 610 and 620 are arranged in the same display row. The pixel circuits 610 and 620 drive the light emitting devices LD1 and LD2 respectively. The pixel circuit 610 includes a driving transistor MD1, transistors M11, M2, M13, and M14, and capacitors C11 and C12. The pixel circuit 620 includes a driving transistor MD2, transistors M21, M2, M23, and M24, and capacitors C21 and C22. In this embodiment, the transistors M2 and M11 to M24 are configured to serve as switches, and the pixel circuits 610 and 620 share the transistor M2.

In terms of coupling relationships, each of the pixel circuits 610 and 620 has a coupling relationship similar to that of the pixel circuit 400 according to the embodiment of FIG. 4, which is not repeated herein. In this embodiment, the pixel circuit 610 is coupled between the source line SL1 and the setting/sensing voltage transmission wire VSW1, and the pixel circuit 620 is coupled between a source line SL2 and a setting/sensing voltage transmission wire VSW2.

In addition, in this embodiment, the common transistor M2 is disposed in the pixel circuit 610. In other embodiments, the common transistor M2 may also be disposed in the pixel circuit 620, which should not be construed as a limitation.

With reference to FIG. 6A and FIG. 6B together, FIG. 6B is a schematic top diagram of a layout structure of a display panel 600 according to the embodiment of FIG. 6A. In FIG. 6B, the display panel 600 has pixel circuits 610, 620, 630, and 640, where the pixel circuits 610 and 620 are arranged in the same display row, and the pixel circuits 630 and 640 are disposed in another same display row. Corresponding to the pixel circuits 610 and 620, the common transistor M2 may be arranged in the middle of the pixel circuits 610 and 620. One end of the transistor M2 receives the power voltage OVDD, and the other end of the transistor M2 is simultaneously coupled to the inside (that is, coupled to the driving transistors MD1 and MD2) of the pixel circuits 610 and 620. Corresponding to the pixel circuits 630 and 640, the common transistor M2′ may be arranged in the middle of the pixel circuits 630 and 640. One end of the transistor M2′ receives the power voltage OVDD, and the other end of the transistor M2′ is simultaneously coupled to the inside (that is, coupled to the driving transistors in the pixel circuits 630 and 640) of the pixel circuits 630 and 640.

By the common transistors M2 and M2′, a significant area of the pixel circuits 610 to 640 may be effectively reduced. Correspondingly, under a fixed layout area, the number of pixel circuits which may be disposed on the display panel 600 may be increased, thereby improving the display resolution of the display panel 600.

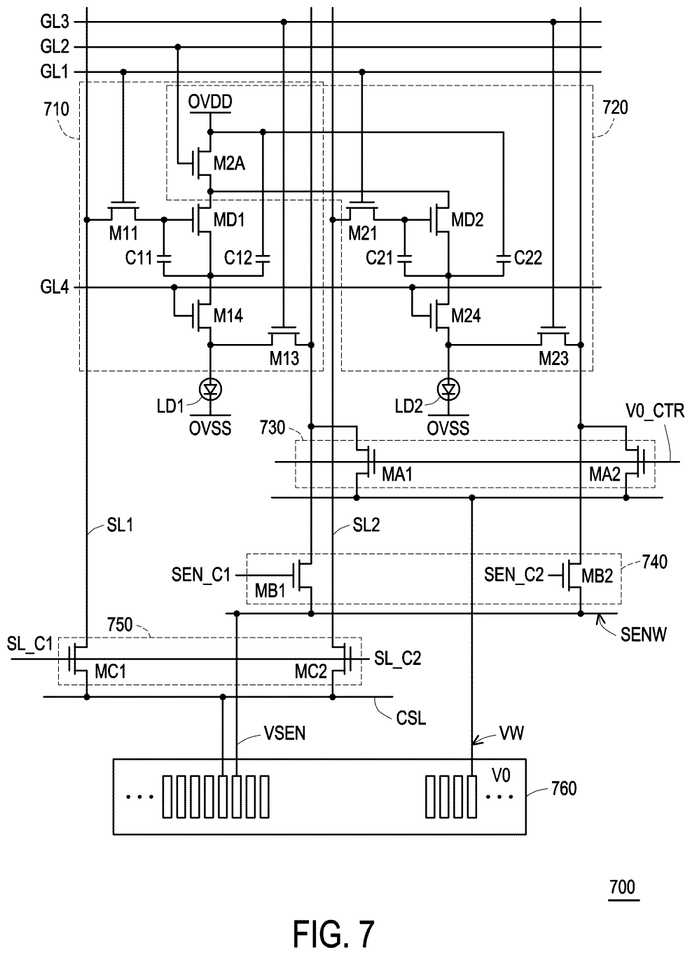

With reference to FIG. 7, FIG. 7 is a schematic diagram of a display panel according to another embodiment of the disclosure. A display panel 700 includes pixel circuits 710, 720, and switch circuits 730 to 750. The pixel circuits 710 and 720 have the same circuit structure as the pixel circuits 610 and 620 in the embodiment of FIG. 6A, which is not repeated herein. It is worth noting that the switch circuit 730 of this embodiment is coupled between a setting voltage transmission wire VW and the setting/sensing voltage transmission wires VSW1 and VSW2. The switch circuit 730 includes transistors MA1 and MA2, where the transistor MA1 serves as a transistor switch and is coupled between the setting voltage transmission wire VW and the setting/sensing voltage transmission wire VSW1, and the transistor MA2 serves as another transistor switch and is coupled between the setting voltage transmission wire VW and the setting/sensing voltage transmission wire VSW2. The transistors MA1 and MA2 are both controlled by a control signal V0_CTR, so that the setting voltage transmission wire VW is isolated from or disconnected from the setting/sensing voltage transmission wires VSW1 and VSW2 according to the control signal V0_CTR.

The switch circuit 740 is coupled between a sensing voltage transmission wire SENW and the setting/sensing voltage transmission wires VSW1 and VSW2. The switch circuit 740 includes transistors MB1 and MB2, where the transistor MB1 serves as a transistor switch and is coupled between the sensing voltage transmission wire SENW and the setting/sensing voltage transmission wire VSW1, and the transistor MB2 serves as another transistor switch and is coupled between the sensing voltage transmission wire SENW and the setting/sensing voltage transmission wire VSW2. The transistors MB1 and MB2 are controlled by the control signals SEC_C1 and SEN_C2 respectively. The transistor MB1 makes the sensing voltage transmission wire SENW and the setting/sensing voltage transmission wire VSW1 connect or disconnect to each other according to the control signal SEC_C1. The transistor MB2 makes the sensing voltage transmission wire SENW and the setting/sensing voltage transmission wire VSW2 connect or disconnect to each other according to the control signal SEC_C2.

The switch circuit 750 is coupled between the common source line CSL and the source lines SL1 and SL2. The switch circuit 750 makes the common source line CSL couple to the source line SL1 or SL2 according to the control signals SL_C1 and SL_C2. The switch circuit 750 includes transistors MC1 and MC2 serving as switches. The transistor MC1 is coupled between the common source line CSL and the source line SL1, and is controlled by the control signal SL_C1. The transistor MC2 is coupled between the common source line CSL and the source line SL2, and is controlled by the control signal SL_C2.

In another aspect, in this embodiment, the common source line CSL, the sensing voltage transmission wire SENW, and the setting voltage transmission wire VW may be coupled to an integrated circuit 760. The integrated circuit 760 may be a driving circuit of the display panel 700. A setting voltage V0 may be generated by the integrated circuit 760 and transmitted to the pixel circuits 710 and 720 by the setting voltage transmission wire VW. In addition, the control signals V0_CTR, SEC_C1, SEC_C2, SL_C1, and SL_C2 may also be provided by the integrated circuit 760.

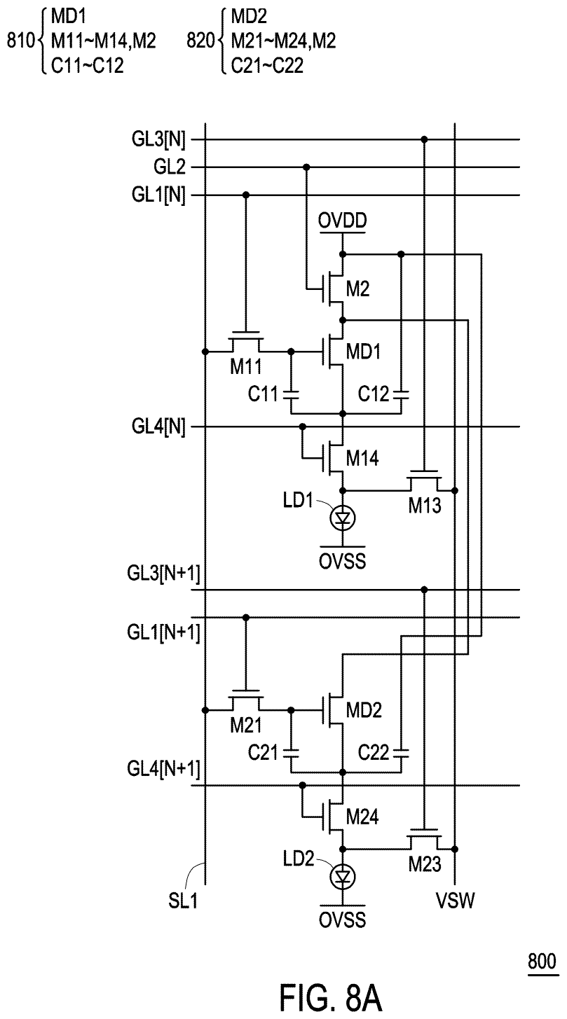

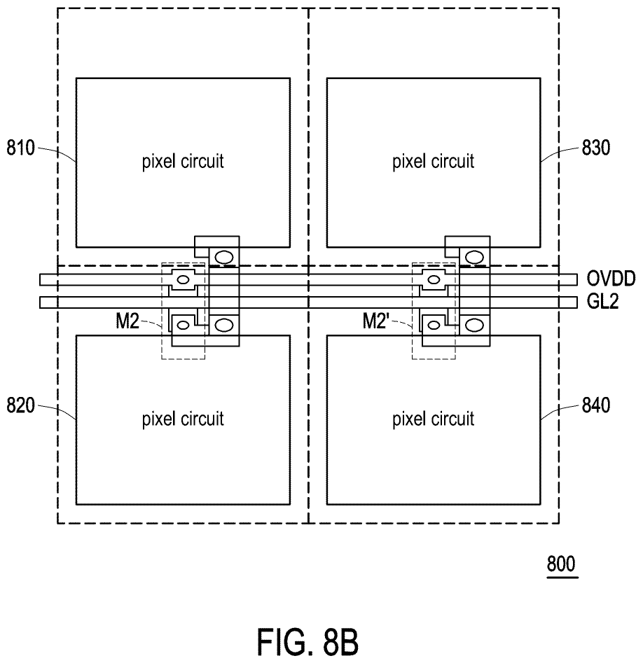

With reference to FIG. 8A, FIG. 8A is a schematic diagram of a display panel according to another embodiment of the disclosure. A display panel 800 includes pixel circuits 810 and 820. The pixel circuits 810 and 820 are arranged in the same display column but in adjacent two display rows. The pixel circuit 810 includes transistors M11 to M14 and M2, a driving transistor MD1, and capacitors C11 and C12. The pixel circuit 820 includes transistors M21 to M24, and M2, a driving transistor MD2, and capacitors C21 and C22. The pixel circuits 810 and 820 share the transistor M2. Each of the pixel circuits 810 and 820 has the same circuit structure as the pixel circuit 400 in the embodiment of FIG. 4, and the relevant operation details are not repeated herein.

It is worth noting that, based on the pixel circuits 810 and 820 being arranged in adjacent two display rows, the transistors M11 to M14 serving as switches in the pixel circuit 810 are controlled by the gate signals GL1[N] to GL4[N] respectively, and the transistors M21 to M24 serving as switches in the pixel circuit 820 are controlled by the gate signals GL1[N+1] to GL4[N+1] respectively. The common transistor M2 is controlled by the gate signal GL2.

It is worth noting that, in this embodiment, the pixel circuits 810 and 820 may share the same source line SL1, and may share the same setting/sensing voltage transmission wire VSW.

With reference to FIG. 8A and FIG. 8B together, FIG. 8B is a schematic top diagram of a layout structure of a display panel 800 according to the embodiment of FIG. 8A. In FIG. 8B, the display panel 800 has pixel circuits 810, 820, 830, and 840. The pixel circuits 810 and 820 are arranged in the same display row, and the pixel circuits 830 and 840 are arranged in another same display row. Corresponding to the pixel circuits 810 and 820, the common transistor M2 may be laid out between the pixel circuits 810 and 820. One end of the transistor M2 receives the power voltage OVDD, and the other end of the transistor M2 is simultaneously coupled to the inside (that is, coupled to the driving transistors MD1 and MD2) of the pixel circuits 810 and 820. Corresponding to the pixel circuits 830 and 840, the common transistor M2′ may be laid out between the pixel circuits 830 and 840. One end of the transistor M2′ receives the power voltage OVDD, and the other end of the transistor M2′ is simultaneously coupled to the inside (that is, coupled to the driving transistors in the pixel circuits 830 and 840) of the pixel circuits 830 and 840.

By the common transistors M2 and M2′, a significant area of the pixel circuits 810 to 840 may be effectively reduced. Correspondingly, the display resolution of the display panel 800 may be improved accordingly.

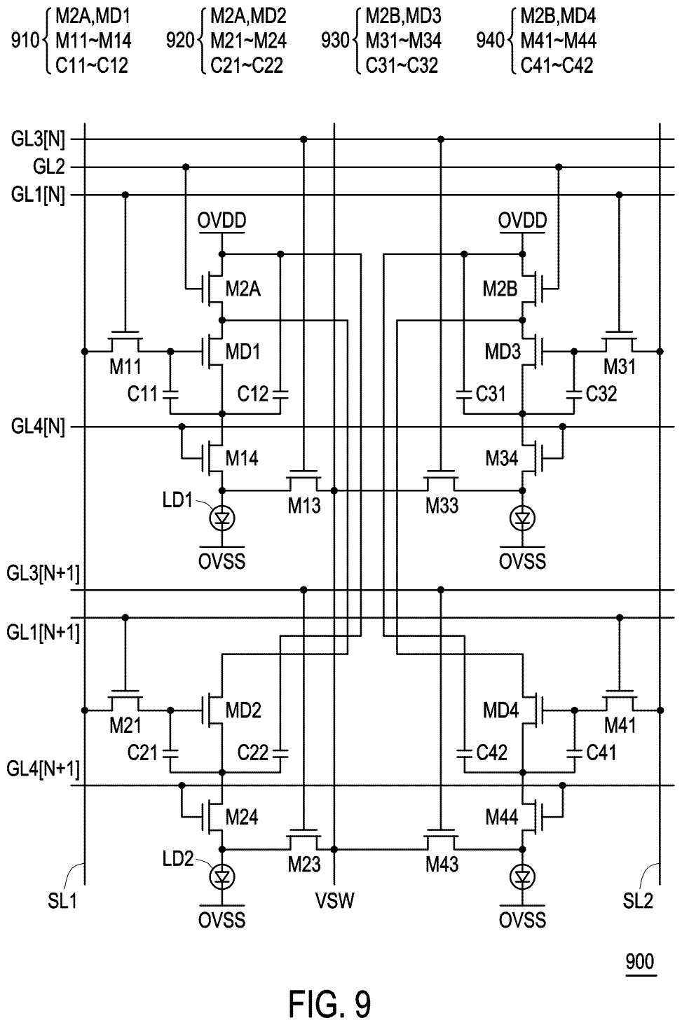

With reference to FIG. 9, FIG. 9 is a schematic diagram of a display panel according to another embodiment of the disclosure. A display panel 900 includes pixel circuits 910 to 940. The pixel circuits 910 and 920 are arranged in the same display column but in adjacent two display rows. The pixel circuits 930 and 940 are arranged in the same display column but in adjacent two display rows. The pixel circuit 910 includes transistors M11 to M14 and M2A, a driving transistor MD1, and capacitors C11, C12. The pixel circuit 920 includes transistors M21 to M24, and M2A, a driving transistor MD2, and capacitors C21, C22. The pixel circuit 930 includes transistors M31 to M34 and M2B, a driving transistor MD3, and capacitors C31, C32. The pixel circuit 940 includes transistors M41 to M44 and M2B, a driving transistor MD4, and capacitors C41, C42.

The transistors M11 to M14 and M31 to M34 serving as switches in the pixel circuits 910 and 930 are controlled by the gate signals GL1[N] to GL4[N] respectively, and the transistors M21 to M24 and M41 to M44 serving as switches in the pixel circuits 920 and 940 are controlled by the gate signals GL1[N+1] to GL4[N+1] respectively. The transistors M2A and M2B are controlled by the gate signal GL2. It is worth noting that, according to other embodiments of the disclosure, the gate signals GL4[N] and GL4[N+1] may be the same gate signal. In other words, the gate signals GL4[N] and GL4[N+1] may be transmitted by the same gate line.

In this embodiment, the pixel circuits 910 and 920 share the transistor M2A, and the pixel circuits 930 and 940 share the transistor M2B. Each of the pixel circuits 910 to 940 has the same circuit structure as the pixel circuit 400 in the embodiment of FIG. 4, and the relevant operation details are not repeated herein. Additionally, the pixel circuits 910 to 940 may share the same setting/sensing voltage transmission wire VSW, the pixel circuits 910 and 920 may share the same source line SL1, and the pixel circuits 930 and 940 may share the same source line SL2.

By the aforementioned common structure of multiple elements, the layout area of the display panel 900 of the embodiment of the disclosure may be further reduced, which may improve the display resolution of the display panel 900.

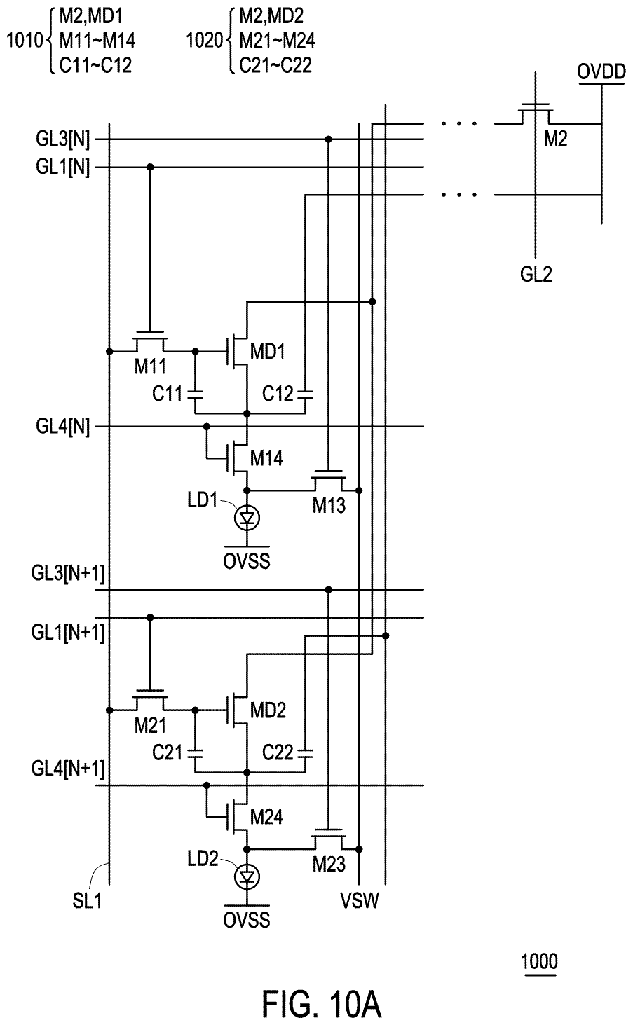

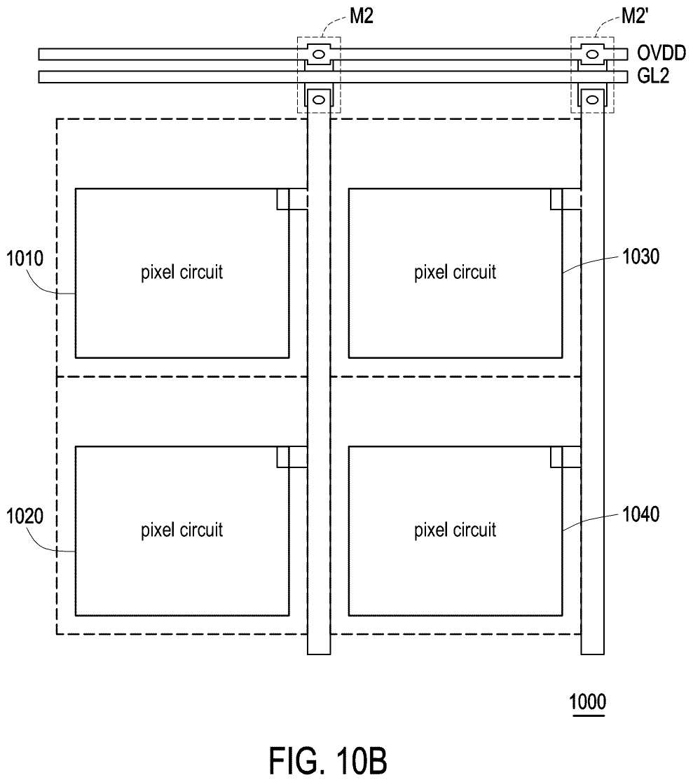

With reference to FIG. 10A, FIG. 10A is a schematic diagram of a display panel according to another embodiment of the disclosure. A display panel 1000 includes pixel circuits 1010 and 1020. The pixel circuits 1010 and 1020 are arranged in the same display row but in adjacent two display rows. The pixel circuit 1010 includes transistors M11 to M14 and M2, a driving transistor MD1, and capacitors C11, C12. The pixel circuit 1020 includes transistors M21 to M24 and M2, a driving transistor MD2, and capacitors C21, C22. The pixel circuits 1010 and 1020 share the transistor M2. Each of the pixel circuits 810 and 820 has the same circuit structure as the pixel circuit 400 in the embodiment of FIG. 4, and the relevant operation details are not repeated herein.

In this embodiment, the common transistor M2 is laid out the outside of the layout area of the transistors M11 to M14 and the transistors M21 to M24. The transistor M2 receives the power voltage OVDD and is controlled by the gate signal GL2. In addition, the transistors M11 to M14 serving as switches in the pixel circuit 1010 are controlled by the gate signals GL1[N] to GL4[N] respectively, and the transistors M21 to M24 serving as switches in the pixel circuit 1020 are controlled by the gate signals GL1[N+1] to GL4[N+1] respectively.

With reference to FIG. 10A and FIG. 10B together, FIG. 10B is a schematic top diagram of a layout structure of a display panel 1000 according to the embodiment of FIG. 10A. In FIG. 10B, the display panel 1000 includes pixel circuits 1010, 1020, 1030, and 1040. The pixel circuits 1010 and 1020 are arranged in the same display column, and the pixel circuits 1030 and 1040 are arranged in another same display column. Corresponding to the pixel circuits 1010 and 1020, the common transistor M2 may be laid out the outside of the pixel circuits 1010 and 1020. One end of the transistor M2 receives the power voltage OVDD, and the other end of the transistor M2 is simultaneously coupled to the inside (that is, coupled to the driving transistors MD1 and MD2) of the pixel circuits 1010 and 1020 and is controlled by the gate signal GL2. Corresponding to the pixel circuits 1030 and 1040, the common transistor M2′ may be laid out the outside of the pixel circuits 1030 and 1040. One end of the transistor M2′ receives the power voltage OVDD, and the other end of the transistor M2′ is simultaneously coupled to the inside (that is, coupled to the driving transistors in the pixel circuits 1030 and 1040) of the pixel circuits 1030 and 1040 and is controlled by the gate signal GL2.

By the common transistors M2 and M2′, a significant area of the pixel circuits 1010 to 1040 may be effectively reduced. Correspondingly, the display resolution of the display panel 1000 may be improved accordingly.

It should be noted that, according to the embodiments of FIG. 6A to FIG. 10B, the pixel circuits may all be implemented by using the pixel circuit 400 according to the embodiment of FIG. 4. According to other embodiments of the disclosure, the pixel circuits of FIG. 6A to FIG. 10B may also be replaced by the pixel circuit 100 according to the embodiment of FIG. 1.

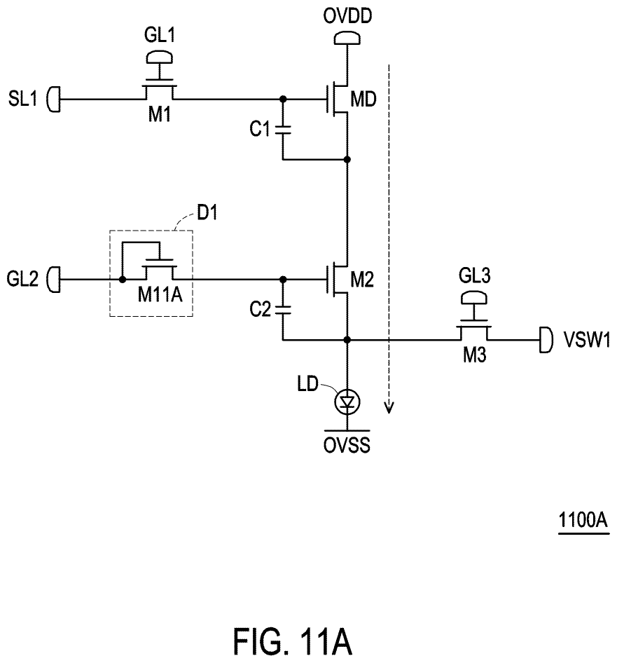

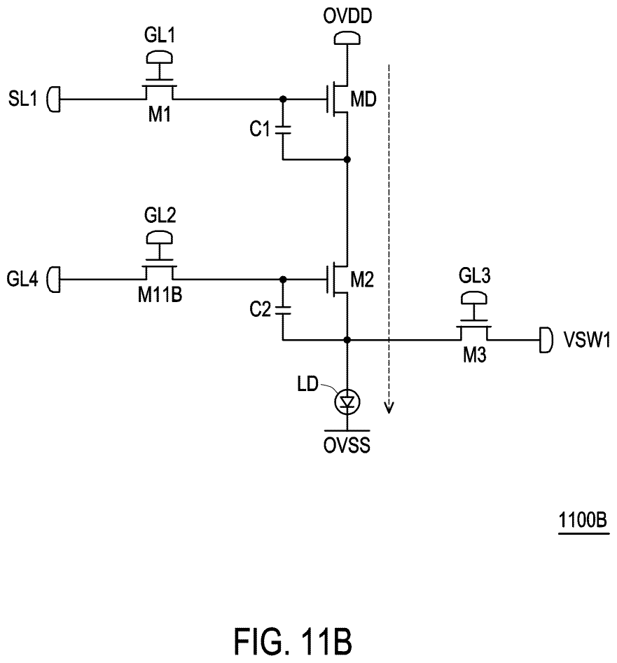

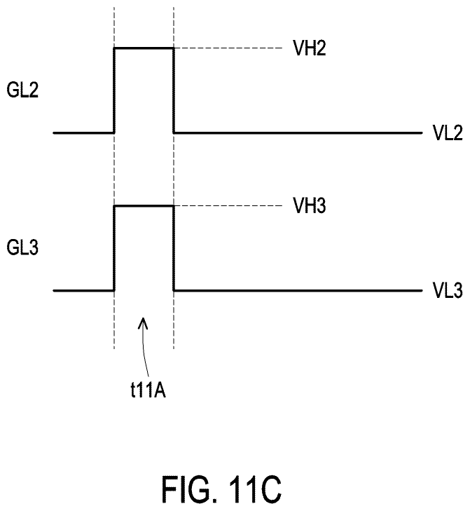

With reference to FIG. 11A to FIG. 11C below, FIG. 11A and FIG. 11B respectively illustrate two different implementations of a pixel circuit according to an embodiment of the disclosure. FIG. 11C illustrates operation waveforms of pixel circuits of FIG. 11A and FIG. 11B. In FIG. 11A, a pixel circuit 1100A includes a driving transistor MD, transistors M1 to M3 and M11A, and capacitors C1 and C2. The transistor M1 to M3 are configured to construct three different switches respectively. The driving transistor MD, the transistor M2 (constituting a second switch), and the light emitting device LD are coupled to each other in series. In this embodiment, the second switch may be coupled between the driving transistor MD and the light emitting device LD.

The first end of the transistor M1 (constituting a first switch) is coupled between the control end of the driving transistor MD and the source line SL1, and is controlled by the gate signal GL1 to be turned on or off. The transistor M3 (constituting a third switch) is coupled between the coupling end point of the transistor M2 and the light emitting device LD and the setting/sensing voltage transmission wire VSW1, and is controlled by the gate signal GL3 to be turned on or off. The capacitor C1 is coupled between the second end and the control end of the driving transistor MD, and the capacitor C2 is coupled between the second end and the control end of the transistor M2.

The transistor M11A is coupled to a diode D1. An anode of the diode D1 receives the gate signal GL2, and a cathode of the diode D1 is coupled to the control end of the transistor M2. The operation details of the pixel circuit 1100A according to this embodiment are generally similar to the pixel circuit 100 according to the embodiment of FIG. 1 of the disclosure, and the same parts are not described in detail. It is worth noting that in this embodiment, as shown in FIG. 11C, the gate signals GL2 and GL3 may be AC signals, and are pulled up from low voltages VL2 and VL3 to high voltages VH2 and VH3 respectively at a time interval t11A to determine the voltage difference between the control end (for instance, the gate) and the second end (for instance, the source) of the transistor M2. At this time, the diode D1 is turned on and provides voltage to the control end of the transistor M2 according to the gate signal GL2. Similarly, the transistor M3 is turned on, and the voltage on the setting/sensing voltage transmission wire VSW1 may be transmitted to the second end of the transistor M2. The capacitor C2 is configured to store the voltage difference between the gate and the source of the transistor M2.

In FIG. 11B, a pixel circuit 1100B includes a driving transistor MD, transistors M1 to M3 and M11B, and capacitors C1 and C2. In this embodiment, the circuit structure of the driving transistor MD, the transistors M1 to M3, and the capacitors C1 and C2 is the same as the circuit structure of the pixel circuit 1100A. The difference lies in that, unlike the transistor M11A, the transistor M11B of this embodiment is not coupled to a diode structure, but is coupled to a switch form. A first end of the transistor M11B receives the gate signal GL4. A second end of the transistor M11B is coupled to the control end of the transistor M2. The transistor M11B is controlled by the gate signal GL2. Similarly, the transistors M11B and M3 may be respectively turned on at the time interval t11A according to the gate signals GL2 and GL3. The control end of the transistor M2 receives the gate signal GL4. The second end of the transistor M2 receives the voltage on the setting/sensing voltage transmission wire VSW1. The capacitor C2 is configured to store the voltage difference between the gate and the source of the transistor M2.

It is worth mentioning that the pixel circuits 1100A and 1100B may also be applied to any of the aforementioned display panels 600, 700, 800, 900, and 1000 of the disclosure.

In summary, in the pixel circuit of the embodiments of the disclosure, the data writing operation and the voltage resetting operation on the control end of the driving transistor are both performed by the same transistor switch which is turned on. In this way, the elements of the pixel circuit may be reduced. In the display panel of the embodiments of the disclosure, by partial circuit elements and transmission conductive wires shared by the pixel circuits, the layout area required by the pixel circuit may be further reduced and improve the display resolution of the display panel.

What is claimed is:

1. A pixel circuit, comprising:
a driving transistor, coupled to a light emitting device in series, and controlled by a driving voltage to drive the light emitting device;
a first switch, coupled between a control end of the driving transistor and a source line, and controlled by a first gate signal;
a second switch, coupled to the driving transistor and the light emitting device in series between a power voltage and a reference ground voltage, and controlled by a second gate signal; and
a third switch, coupled between the light emitting device and a setting/sensing voltage transmission wire, and controlled by a third gate signal,
wherein a data writing operation and a voltage resetting operation on the control end of the driving transistor are performed by the same first switch when turned on.

2. The pixel circuit according to claim 1, further comprising:
a capacitor, coupled between the control end of the driving transistor and a coupling end point of the driving transistor and the light emitting device.

3. The pixel circuit according to claim 1, wherein in a first phase, the first switch and the third switch are turned on, the second switch is turned off, the first switch transmits a voltage on the source line to the control end of the driving transistor to reset the voltage on the control end of the driving transistor, and the third switch transmits a setting voltage to a first coupling end point of the driving transistor and the light emitting device to set a voltage of the first coupling end point.

4. The pixel circuit according to claim 3, wherein in the first phase, the voltage on the source line is a reference voltage less than a threshold value.

5. The pixel circuit according to claim 3, wherein in a second phase, the first switch and the second switch are turned on, the third switch is turned off, the driving transistor receives the power voltage by the second switch, and a capacitor is configured to store relevant information of a conduction voltage of the driving transistor.

6. The pixel circuit according to claim 5, wherein in the second phase, a sum of the setting voltage, the conduction voltage of the driving transistor, and the voltage on the source line is less than a sum of a conduction voltage of the light emitting device and the reference ground voltage.

7. The pixel circuit according to claim 5, wherein in a third phase, the first switch is turned on, the second switch and the third switch are turned off, and the first switch transmits display data on the source line to the control end of the driving transistor.

8. The pixel circuit according to claim 7, wherein in a fourth phase, the second switch is turned on, the first switch and the third switch are turned off, the driving transistor generates a driving current to drive the light emitting device according to the display data, and the second switch transmits a voltage on the light emitting device to the setting/sensing voltage transmission wire.

9. The pixel circuit according to claim 8, further comprising:
a fourth switch, coupled to a coupling path of the driving transistor and the light emitting device, wherein a first end of the fourth switch is coupled to the driving transistor, a second end of the fourth switch is coupled to the light emitting device and the second switch, and the fourth switch is controlled by a fourth gate signal.

10. The pixel circuit according to claim 9, wherein the fourth switch is turned on in the first phase and the fourth phase, and is turned off in the second phase and the third phase.

11. The pixel circuit according to claim 10, wherein the fourth switch is configured to isolate the light emitting device and the driving transistor in the second phase and the third phase.

12. The pixel circuit according to claim 1, wherein the second switch is coupled between the driving transistor and the light emitting device, and the pixel circuit further comprises:
a diode, having an anode to receive the second gate signal, wherein a cathode of the diode is coupled to a control end of the second switch.

13. The pixel circuit according to claim 1, wherein the second switch is coupled between the driving transistor and the light emitting device, and the pixel circuit further comprises:
a fourth switch, having a first end to receive a fourth gate signal, wherein a control end of the fourth switch receives the second gate signal, and a second end of the fourth switch is coupled to a control end of the second switch.

14. The pixel circuit according to claim 12, further comprising:
a capacitor, coupled between the control end of the second switch and the light emitting device.

15. The pixel circuit according to claim 13, further comprising:
a capacitor, coupled between the control end of the second switch and the light emitting device.

16. A display panel, comprising:
a first pixel circuit, comprising:
a first driving transistor, coupled to a first light emitting device in series, and controlled by a first driving voltage to drive the light emitting device;
a first switch, coupled between a control end of the first driving transistor and a first source line, and controlled by a first gate signal;
a second switch, coupled to the first driving transistor and the first light emitting device in series between a power voltage and a reference ground voltage, and controlled by a second gate signal; and
a third switch, coupled between the first light emitting device and a first setting/sensing voltage transmission wire, and controlled by a third gate signal; and
a second pixel circuit, comprising:
a second driving transistor, coupled to a second light emitting device in series, and controlled by a second driving voltage to drive the light emitting device;
a fourth switch, coupled between a control end of the second driving transistor and a second source line, and controlled by the first gate signal;
the second switch, coupled to the second driving transistor and the second light emitting device in series between the power voltage and the reference ground voltage; and
a fifth switch, coupled between the second light emitting device and a second setting/sensing voltage transmission wire, and controlled by the third gate signal,
wherein a data writing operation and a voltage resetting operation on the control end of the first driving transistor are performed by the same first switch when turned on, and a data writing operation and a voltage resetting operation on the control end of the second driving transistor are performed by the same fourth switch when turned on.

17. The display panel according to claim 16, wherein the first pixel circuit further comprises a first capacitor, and the first capacitor is coupled between the control end of the first driving transistor and a coupling end point of the first driving transistor and the first light emitting device; and
the second pixel circuit further comprises a second capacitor, and the second capacitor is coupled between the control end of the second driving transistor and a coupling end point of the second driving transistor and the second light emitting device.

18. The display panel according to claim 16, wherein the first pixel circuit further comprises:
a sixth switch, coupled to a coupling path of the first driving transistor and the first light emitting device, wherein a first end of the sixth switch is coupled to the first driving transistor, a second end of the sixth switch is coupled to the first light emitting device and the second switch, and the sixth switch is controlled by a fourth gate signal; and
the second pixel circuit further comprises:
a seventh switch, coupled to a coupling path of the second driving transistor and the second light emitting device, wherein a first end of the seventh switch is coupled to the second driving transistor, a second end of the seventh switch is coupled to the second light emitting device and the second switch, and the seventh switch is controlled by a fifth gate signal.

19. The display panel according to claim 18, wherein the fourth gate signal and the fifth gate signal are the same signal.

20. The display panel according to claim 16, wherein the first pixel circuit and the second pixel circuit are arranged in a same display column, or are arranged in a same display row 21. The display panel of claim 16, wherein the first source line and the second source line are the same source line.

22. The display panel according to claim 16, wherein the first setting/sensing voltage transmission wire and the second setting/sensing voltage transmission wire are same transmission conductive wires.

23. The display panel according to claim 16, further comprising:
a first switch circuit, coupled between a setting voltage transmission wire, the first setting/sensing voltage transmission wire, and the second setting/sensing voltage transmission wire, wherein the first switch circuit is configured to couple the setting voltage transmission wire to the first setting/sensing voltage transmission wire and the second setting/sensing voltage transmission wire according to a first control signal; and
a second switch circuit, coupled between a sensing voltage transmission wire, the first setting/sensing voltage transmission wire, and the second setting/sensing voltage transmission wire, wherein the second switch circuit is configured to couple the sensing voltage transmission wire to the first setting/sensing voltage transmission wire or the second setting/sensing voltage transmission wire according to a second control signal.

24. The display panel according to claim 23, further comprising:
a third switch circuit, coupled between a common source line, the first source line, and the second source line, and configured to couple the common source line to the first source line or the second source line according to a third control signal.
